(19) United States
(12) Patent Application Publication
(10) Pub. No.: US 2026/0322851 A1
(43) Pub. Date: Oct. 15, 2026

(54) LINK RISK ANALYSIS FOR CONTENT DISTRIBUTION PLATFORM

(71) Applicant: Bytedance Technology Ltd., Grand Cayman (KY)

(72) Inventors: Jingyuan Yi, Culver City, CA (US); Qian HUANG, Culver City, CA (US); Junyu WANG, Los Angeles, CA (US); Alisha Chandra SINGH, Culver City, CA (US)

(21) Appl. No.: 19/178,451

(22) Filed: Apr. 14, 2025

(51) Int. Cl. H04L 9/40; H04L 67/146

(52) U.S. Cl. CPC H04L 63/145; H04L 63/1408; H04L 67/146

(57) ABSTRACT

A computing system includes a processor and a storage device holding instructions executable by the processor to receive a user input to add a link representation to graphical content for distribution, wherein the link representation includes one or more characters of display text and a link to web content. A plurality of link risk parameters associated with the link representation are input to a risk analysis subsystem. The link risk parameters include at least one of the graphical content, the one or more characters of display text, the link to the web content, or one or more web content parameters. At the risk analysis subsystem, the plurality of link risk parameters are analyzed to determine a risk classification for the link representation based at least in part on one or more risk criteria. The risk analysis system outputs the risk classification for the link representation.

### BACKGROUND

Content distribution platforms enable users to share various forms of graphical content, such as images or videos, with other users. Such platforms may enable the graphical content to be shared along with user-specified text, which may include links to external web content.

### SUMMARY

A computing system includes a processor and a storage device holding instructions executable by the processor to receive a user input to add a link representation to one or more items of graphical content for distribution using a content distribution platform, wherein the link representation includes one or more characters of display text and a link to web content. A plurality of link risk parameters associated with the link representation are input to a risk analysis subsystem, wherein the link risk parameters include at least one of the one or more items of graphical content, the one or more characters of display text, the link to the web content, or one or more web content parameters associated with the web content. At the risk analysis subsystem, the plurality of link risk parameters are analyzed to determine a risk classification for the link representation based at least in part on one or more risk criteria. The risk analysis system outputs the risk classification for the link representation.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIGS. 1A and 1B schematically depict the use of a computing system to output a risk classification for a link representation.

FIGS. 2A-2C depict an example user interface useable to add a link representation to graphical content.

FIGS. 3A-3C illustrate use of an example user interface to select a link representation distributed using a content distribution platform.

FIG. 4 illustrates the use of an example user interface to prevent access to web content based on the assessed risk of a link representation.

FIG. 5 illustrates an example method for link risk analysis in a content distribution platform.

FIG. 6 schematically shows an example computing system.

### DETAILED DESCRIPTION

Content distribution platforms allow users to share graphical content, such as images and/or videos, for viewing by other users. In some cases, the graphical content may include links directing viewers to external web content. While such functionality may enhance user engagement and facilitate the dissemination of information, it also introduces security and integrity challenges. Specifically, when users are permitted to share arbitrary links, there is a risk that some links may lead to malicious, deceptive, or otherwise harmful web content.

Accordingly, the present disclosure is directed to techniques for automatic link risk analysis in a content distribution platform. According to the techniques described herein, a computing system receives a user input to add a link representation to one or more items of graphical content (e.g., an image or video) for distribution via a content distribution platform. The link representation includes one or more characters of display text and a link to web content. The system further inputs a plurality of link risk parameters associated with the link representation to a risk analysis subsystem. These link risk parameters include at least one of the one or more items of the graphical content, the display text, the web content link, or one or more web content parameters. The risk analysis subsystem analyzes the link risk parameters based on one or more risk criteria to determine a risk classification for the link representation. The system then outputs the risk classification, which may be selected from two or more link risk classes corresponding to different levels of risk. Based on the risk classification, the system may in some cases take action to limit or discontinue distribution of the link representation and/or the one or more items of graphical content.

In this manner, the computing systems described herein may provide a more robust and context-aware risk assessment mechanism for evaluating link representations distributed along with graphical content. By incorporating multiple link risk parameters, such as the graphical content itself, the display text associated with the link, and attributes of the linked web content, the system may detect attack vectors that traditional methods may overlook, such as visually deceptive links or misleading text representations. In some examples, link risk analysis may be performed asynchronously—e.g., links may be analyzed on an ongoing basis after a link representation has been submitted by a user and distributed to viewers, rather than only upon initial submission of the link representation. This can beneficially catch scenarios where the web content linked to by the link representation changes over time. In this manner, the techniques described herein beneficially improve the security and user experience associated with the content distribution platform, as users can have more trust that any link representations associated with graphical content are safe.

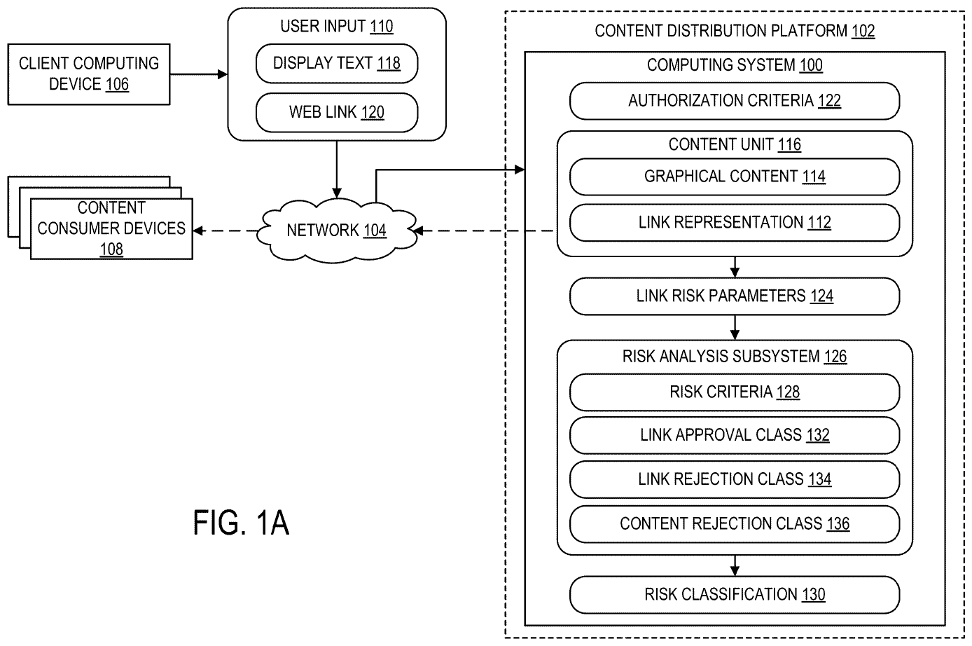

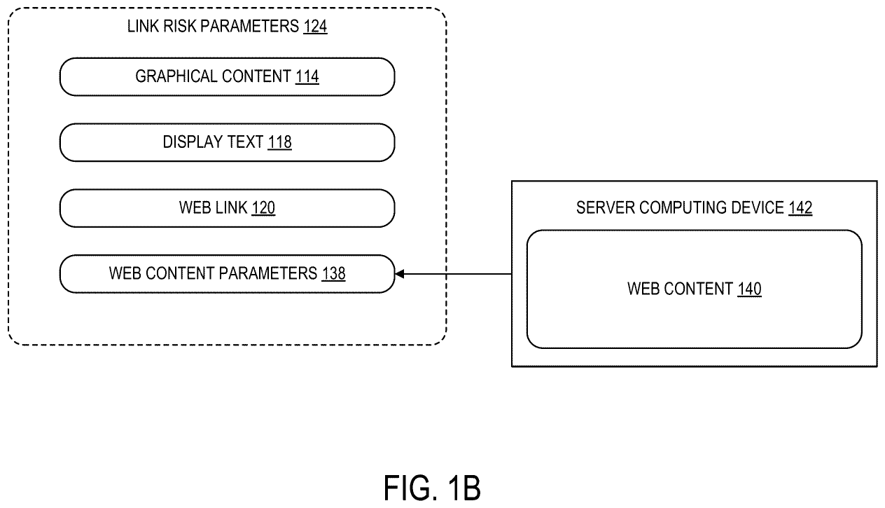

FIG. 1A schematically shows an example computing system 100, which is used to implement a content distribution platform 102. As used herein, a “content distribution platform” refers to a suitable computing system, service, or network that facilitates the dissemination of digital content to users. A content distribution platform may support various types of content, including but not limited to images, videos, text posts, and/or interactive media. Such platforms may enable users to create, upload, modify, and/or share content with others, either publicly or within specified user groups. Examples of content distribution platforms include social media networks, video-sharing services, online forums, and digital advertising systems.

In FIG. 1A, a computer network 104 communicatively couples computing system 100 with a client computing device 106, from which it receives data to be distributed using the content distribution platform. Additionally, network 104 communicatively couples computing system 100 with a plurality of content consumer devices 108, which receive content distributed using the content distribution platform. Network 104 may take the form of any suitable computer network, such as the Internet.

In the example of FIG. 1A, computing system 100 is the only depicted aspect of the content distribution platform 102. However, it will be understood that a content distribution platform may include any suitable number of different computing systems, which may be configured to perform the same or different functions as computing system 100. For instance, the functions of computing system 100 may in some cases be performed by two or more computing devices working cooperatively. As non-limiting examples, the content distribution platform may be implemented by computing devices configured to handle user authentication, manage content storage and retrieval, process content moderation requests, execute machine learning-based content analysis, and/or facilitate data transmission between users and the platform.

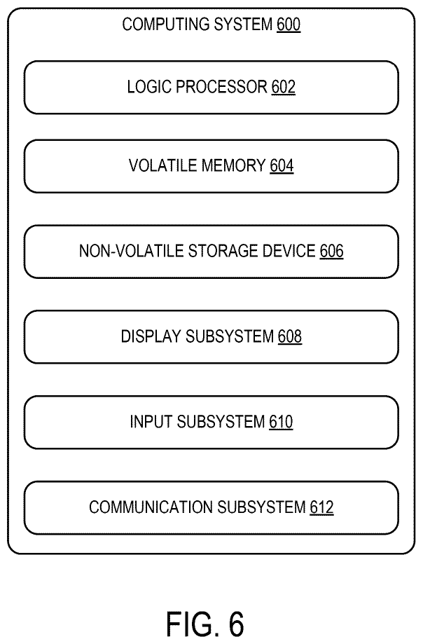

Each of the client computing device 106, content consumer devices 108, computing system 100, and/or any other computing devices used to implement the content distribution platform, may have any suitable capabilities, hardware configuration, and form factor. Any or all of these computing devices may be implemented as computing system 600 described below with respect to FIG. 6.

In FIG. 1A, client computing device 106 transmits a user input 110 to content distribution platform 102. The user input is a request to associate a link representation 112 with one or more items of graphical content 114 for distribution to other users using the content distribution platform. In FIG. 1A, the graphical content and link representation together are referred to as a content unit 116, which may be described as a “post” or “story” or other shareable unit of digital content, depending on the implementation.

The user input may be provided in any suitable way. For instance, aspects of the link representation and its placement relative to the graphical content may be specified by a user interacting with a user interface (UI) rendered by client computing device 106. Additionally, or alternatively, in some examples, the user input may be generated by an automated process implemented on the client computing device—e.g., after the user previously provided the automated service with authorization to interact with the content distribution platform on the user's behalf.

As used herein, “graphical content” refers to any suitable digital media that includes one or more visual elements such as images, videos, animations, and/or other graphics. Graphical content may be static or dynamic and can be presented independently or as part of a larger content item. In the context of a content distribution platform, graphical content may be user-provided or platform-provided, and may support additional elements such as embedded text, overlays, annotations, and/or links to web content. Graphical content may be stored in various formats, including raster or vector images, video files, interactive multimedia, etc.

In some examples, the user may provide the graphical content for inclusion in the content unit. For instance, the graphical content may be uploaded to the content distribution platform by the client computing device, at the same time the link representation is specified, or at another suitable time. Additionally, or alternatively, the graphical content may include content included in a content library associated with the content distribution platform, a public domain content library, and/or graphical content associated with another user (e.g., the user of client computing device 106 may be “reposting” or “sharing” graphical content originally uploaded by another user).

Furthermore, a “link representation” refers to any suitable visual or textual element within a content unit that conveys the presence of a link to web content. A link representation may include one or more characters of display text, an embedded hyperlink, a button, an icon, and/or other suitable visual components. In some implementations, a link representation may be overlaid on the graphical content, or presented alongside the graphical content, when viewed by users of the content distribution platform. The appearance and behavior of a link representation may be influenced by formatting choices, platform policies, and/or automated modifications based on risk analysis or content moderation processes.

In FIG. 1A, the link representation includes one or more characters of display text 118, and a link 120 to web content, each of which are specified by user input 110. The link 120 to web content takes the form of any suitable data element that specifies a network address or resource identifier associated with web-based content. A link to web content may be represented as a Uniform Resource Locator (URL), Uniform Resource Identifier (URI), or another suitable reference format that enables access to an external web page, file, or online service.

The link representation is included as part of the content unit, for distribution using the content distribution platform. As will be discussed in more detail below, the link representation may have any suitable visual characteristics. In some cases, the link may be represented by one or more display characters that differ from the link itself. In other words, the link may be visually presented using display text that differs from the underlying web address or resource identifier. For example, the link representation may include a word, phrase, or call-to-action (e.g., “Click here” or “Learn more”) that, when selected, directs a user to the linked web content. In some implementations, the link representation may be embedded within a graphical element, such as an image, button, or icon, where the visual appearance of the element serves as the interactive component rather than displaying the link text directly. The link representation may incorporate formatting attributes such as font style, color, size, and/or graphical overlays to enhance visibility, match platform aesthetics, and/or comply with content policies. It will be understood that the one or more characters of display text need not always differ from the link itself—rather, in some examples, the one or more characters of display text may include the link itself, or a subset of the link characters.

Once user input 110 is received, the content distribution platform may begin distributing the content unit 116, including the one or more items of graphical content 114 and link representation 112, to other users for viewing. For instance, in the example of FIG. 1A, the content unit is distributed to content consumer devices 108 using network 104. It will be understood that, while FIG. 1A focuses on a scenario where the content distribution platform receives data from client computing device 106 and distributes data to the content consumer devices 108, this is not limiting. For instance, in some cases, client computing device 106 may additionally or alternatively receive data distributed by the content distribution platform (e.g., data posted by other users). Similarly, the content consumer devices 108 may additionally or alternatively send data to the content distribution platform for distribution.

As discussed above, inclusion of a link representation with the one or more items of graphical content can introduce security challenges. Specifically, when users are permitted to share arbitrary links, there is a risk that some links may lead to malicious, deceptive, or otherwise harmful web content. To this end, the present disclosure describes techniques for automatically analyzing link representations to classify their level of risk. Such analysis may be performed prior to, and/or during, distribution of the one or more items of graphical content with the link representation.

For instance, in some examples, the computing system may perform a preliminary risk analysis prior to distribution of the graphical content and the link representation using the content distribution platform. In some cases, the preliminary risk analysis may be performed relatively quickly, to rapidly provide the user with either an approval or rejection of the content they submitted. A relatively longer and more thorough analysis may be performed subsequently, during ongoing distribution of the content unit, as will be described in more detail below. In one example scenario, the preliminary risk analysis may include determining whether the display text and the link to the web content include any blacklisted character strings. In this manner, the system may determine if the display text and/or web link include any sensitive language, slurs, references to topics not permitted by the platform's moderation policy, etc. Additionally, or alternatively, other suitable aspects of the link representation may be checked during the preliminary risk analysis, including any or all of the link risk parameters that will be described in more detail below.

Furthermore, in some examples, the computing system may determine whether the user submitting the link representation satisfies one or more authorization criteria, prior to distribution of the link representation using the content distribution platform. For instance, in FIG. 1A, computing system 100 maintains a set of authorization criteria 122, which may be checked in order to determine whether the user is authorized to share the link representation. As non-limiting examples, the authorization criteria may include one or more of a follower or subscriber count of the user, prior content posting history for the user, and/or prior content moderation history for the user. As examples, the user may be blocked from adding a link representation to the graphical content if their follower count is below a threshold, if they have a history of moderation actions being applied to their posted content, if they have a history of posting content that relates to sensitive or high-risk topics, etc. Additional examples of authorization criteria may include, but are not limited to, the verification status of the user account, the geographic location of the user, whether the user has completed a specific authentication process (e.g., multi-factor authentication or identity verification), etc. In some implementations, different authorization levels may be defined, where certain users (e.g., those with long-standing positive engagement histories) may be granted broader permissions to share links, while newer or lower-authority users may face additional restrictions or review processes.

The authorization criteria may be evaluated by the content distribution platform using one or more automated or manual review processes. In some implementations, the platform may maintain a user profile that includes relevant attributes such as account age, engagement metrics, prior content submissions, and moderation history. When a user attempts to add a link representation to graphical content, the platform may retrieve and analyze these attributes to determine whether the user meets the authorization criteria. This analysis may be performed in real time and/or as part of a periodic review process applied to users attempting to share link representations.

Further, the authorization criteria may be dynamically adjusted based on risk factors associated with the specific link representation or the external web content. For example, links pointing to newly registered domains, domains with a history of hosting harmful content, and/or links including obfuscated URL parameters may require a higher level of user authorization. In such cases, even if a user generally meets the platform's standard criteria, additional verification steps and/or platform-administered content reviews may be performed before the link representation is approved for distribution.

The relative risk of the link representation itself may be assessed by inputting a plurality of link risk parameters to a risk analysis subsystem. In the example of FIG. 1A, a plurality of link risk parameters 124 are derived from the link representation 112, and input to a risk analysis subsystem 126 of the computing system. In general, a “link risk parameter” refers to any suitable data attribute associated with a link representation that is useable to assess the potential risk of the link within the content distribution platform. A link risk parameter may include characteristics of the link itself, such as the link structure (e.g., URL format), domain reputation, and/or presence of obfuscation techniques. Additionally, or alternatively, link risk parameters may include contextual factors, such as the graphical content in which the link is embedded, the display text associated with the link, metadata related to the linked web content, and/or historical engagement data for similar links. Additional details regarding link risk parameters will be provided below with respect to FIG. 1B.

Furthermore, a “risk analysis subsystem” refers to any suitable aspect of a computing system configured to evaluate link risk parameters and determine a risk classification for a link representation. The risk analysis subsystem may be implemented through any suitable combination of hardware devices and/or software processes. The risk analysis subsystem may apply one or more risk assessment techniques, including rule-based filtering, heuristic analysis, machine learning models, and/or historical data comparisons, to identify potential security threats, policy violations, and/or other risks associated with a link representation. The risk analysis subsystem may operate in real time or as part of a batch processing system, and may generate outputs such as risk classifications, confidence scores, and/or recommended actions for content moderation or user notifications.

In the example of FIG. 1A, the risk analysis system 126 receives the plurality of link risk parameters 124 and evaluates them against a plurality of risk criteria 128. Any suitable risk criteria may be used depending on the implementation. As examples, the one or more risk criteria may include a blacklist of character strings forbidden from inclusion in the display text and web link, a format of the web link (e.g., whether the input characters are properly formatted as a link, whether any link shortening or obfuscation techniques were used), a topic of the graphical content, and/or a topic of the web content.

More generally, the risk criteria 128 may include any of a wide range of suitable factors chosen to assess potential security threats, policy violations, and/or deceptive practices associated with a link representation. For instance, the risk criteria may consider the reputation of the domain hosting the linked web content, the age of the domain, whether the link redirects through multiple intermediary sites, the presence of tracking parameters in the URL, and/or historical engagement data for similar links. Additionally, or alternatively, the criteria may include content-based analysis, such as detecting whether the linked web content includes phishing indicators, malware, or misinformation.

The topic of the graphical content and the topic of the web content may be inferred using various suitable computational techniques. For graphical content, topic inference may involve applying trained image recognition/classification models, optical character recognition (OCR) techniques to extract and analyze embedded text, and/or feature extraction techniques to classify visual elements. For example, if the graphical content includes text related to financial services, product promotions, or medical claims, it may be categorized under corresponding topics. Similarly, for video-based graphical content, automated speech recognition (ASR) may be used to transcribe spoken words, which can then be analyzed to determine the topic.

For web content, topic inference may involve natural language processing (NLP) techniques to analyze the text content of the linked web page, and thereby identify keywords, entities, and/or overall semantic meaning. Web content classification models may be used to assign the page to predefined categories, such as news, e-commerce, health, or social networking. Additionally, or alternatively, metadata associated with the web content, such as HTML tags, may provide indicators of the content's topic. If the inferred topics of the graphical content and the web content are inconsistent or indicative of a potential deceptive practice—such as an image suggesting official government assistance while linking to an unrelated commercial site—the risk analysis subsystem may classify the link representation with a higher risk level.

In FIG. 1A, the risk analysis subsystem analyzes the plurality of link risk parameters against the risk criteria to determine a risk classification 130 for the link representation. The risk analysis system then outputs the risk classification. The risk classification may be selected from two or more link risk classes depending on the analysis performed by the risk analysis subsystem. The different link risk classes may result in different behavior at the content distribution platform, depending on the level of risk presented by the link representation.

For instance, in some examples, the risk classification for the link representation may in some cases be output by the risk analysis subsystem during ongoing distribution of the graphical content and the link representation using the content distribution platform. As discussed above, this may represent an asynchronous analysis of the link representation that occurs some amount of time (e.g., minutes, hours, days) after the link representation is submitted to the content distribution platform, and distribution of the link representation is initiated. In some cases, this asynchronous analysis may follow a preliminary risk analysis performed when the link representation is initially submitted, as discussed above. Thus, in response to the risk classification for the link representation indicating potential risk, the computing system may discontinue distribution of the link representation using the content distribution platform. In cases where the risk analysis is performed prior to distribution of the link representation, then such distribution may be prevented before it begins—e.g., the user may be provided with a notification that their link was rejected.

The risk classification may be selected from any suitable number of different risk classes maintained by the computing system, each of which may be indicative of different relative risk levels, and result in different behavior when output by the risk analysis system. For instance, in FIG. 1A, the risk analysis subsystem maintains three different link risk classes, including a link approval class 132 that permits distribution of the link representation using the content distribution platform, a link rejection class 134 that causes the content distribution platform to prevent access to the web content upon selection of the link representation, and a content rejection class 136 that prevents distribution of the graphical content using the content distribution platform.

As used herein, “outputting” a risk classification may include writing the classification to a file, storing the classification in memory, transmitting the classification to another computing system, displaying the classification via a user interface, and/or embedding the classification as metadata associated with the corresponding content unit. In some implementations, the classification may be logged for audit or reporting purposes, used to trigger automated moderation actions, and/or incorporated into a risk assessment database for future reference. Additionally, or alternatively, the classification may be provided as input to other systems, such as a content distribution platform's policy enforcement module, which may determine whether to restrict, flag, or allow the link representation based on the assigned classification. The classification may in some cases be updated dynamically if new or changed risk parameters become available, ensuring that content moderation decisions remain responsive to evolving security threats and platform policies. For instance, in some examples, the system may continuously monitor how often the link representation is selected by users to access the linked web content. In response to detecting that the link representation is used to access the web content more than a threshold number of times, the link representation may be flagged for manual and/or further automated review, as a high frequency of access can pose a relatively greater degree of risk.

FIG. 1B schematically depicts link risk parameters 124 in more detail. As shown, in this example, the link risk parameters include the graphical content 114 itself (e.g., which may be analyzed using trained image recognition/classification models, OCR methods, etc.), the one or more characters of display text 118 and the web link 120 of the link representation (e.g., which may be compared to character blacklists as discussed above), along with web content parameters 138 associated with the external web content that the web link directs to. As shown, in this example, the web link directs to web content 140 hosted by a remote server computing device 142. The web content parameters 138 are derived from the web content. As non-limiting examples, the web content parameters may include one or more of text data of the web content, image data of the web content, and a quantity of link redirects caused by selection of the link to the web content. In this manner, the system may determine the topic of the web content and detect potential risk factors associated with the web content, such as a relatively high number of redirects. Any or all of these link risk parameters may be input to the risk analysis subsystem to classify the level of risk presented by the link representation, as discussed above.

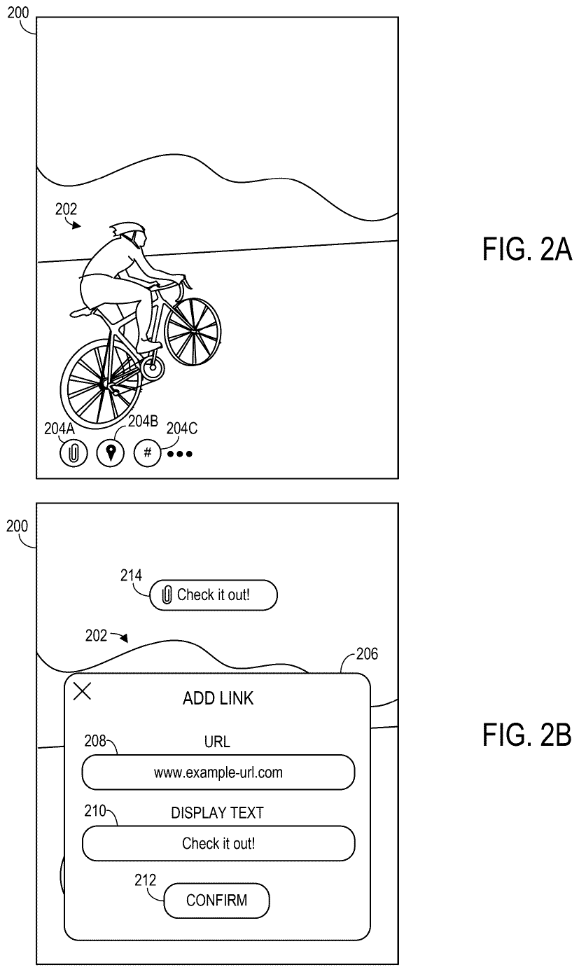

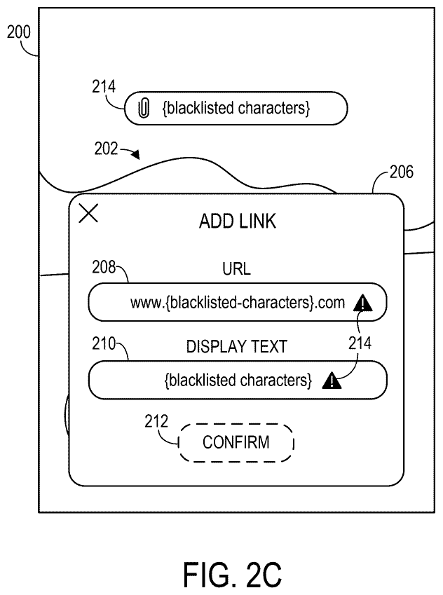

FIGS. 2A-2C depict an example user interface (UI) 200 that may be used by a user of the content distribution platform to associate a link representation with graphical content, for distribution to other users. It will be understood that the appearance of UI 200 is simplified and non-limiting, and presented only for the sake of explanation. In other examples, the UI may have another suitable appearance and provide additional or alternative functionality.

As shown, the UI displays graphical content 202, along with a plurality of interface controls 204A, 204B, and 204C. As discussed above, the graphical content may take any suitable form, such as an image or video. Selection of interface control 204A enables the user to add a link representation to the graphical content, such that the link representation is distributed to other users along with the graphical content. Other functions may be provided upon selection of interface controls 204B and 204C, along with any other interface controls that may be included in the UI.

In FIG. 2B, the user has selected interface control 204A, causing display of a link representation editor interface 206. This enables the user to specify the web link 208 for the link representation, along with the characters of display text 210 for the link representation. The editor interface includes a confirmation control 212 that, when selected, submits the link representation for distribution. Additionally, a preview link representation 214 is shown based on the user's selections.

As discussed above, in some examples, one or more visual properties of the link representation are customizable. This may include a position of the link representation relative to the graphical content, a size of the link representation, a font style or color of any display text, a transparency level or background shading applied to the link representation, and/or an icon or graphical indicator associated with the link. In some implementations, customization options may allow users to select predefined styles, apply platform-specified formatting rules, and/or dynamically adjust visual properties based on content type. Additionally, or alternatively, the visibility of the link representation may be modified, such as by allowing it to appear only on user interaction (e.g., hovering or tapping) or integrating it within graphical elements. Customization settings may be restricted based on platform policies to prevent deceptive practices, such as making the link representation visually indistinguishable from the surrounding content.

FIG. 2C illustrates a scenario where the user has attempted to submit display text and a web link that is not consistent with the moderation policies of the content distribution platform. As shown, in this example, the web link 208 and display text 210 include blacklisted character strings. In the example of FIG. 2C, the link representation has not yet been distributed, and thus the user's submitted link representation was rejected by a preliminary risk analysis, as discussed above. It will be understood that, in some examples, the link representation may be rejected by an asynchronous link analysis that occurs during ongoing distribution of the graphical content, and the user may be notified of this rejection in any suitable way. In FIG. 2C, the editor interface now includes warning symbols 214 indicating to the user that their link representation is not suitable for distribution. In some examples, these may be accompanied by an explanation as to why the content is not suitable. Alternatively, in some examples, the platform may be relatively vague as to why the content is rejected, to avoid scenarios where users attempt to exploit the system by making minor, non-substantive changes to the link representation they submitted for review.

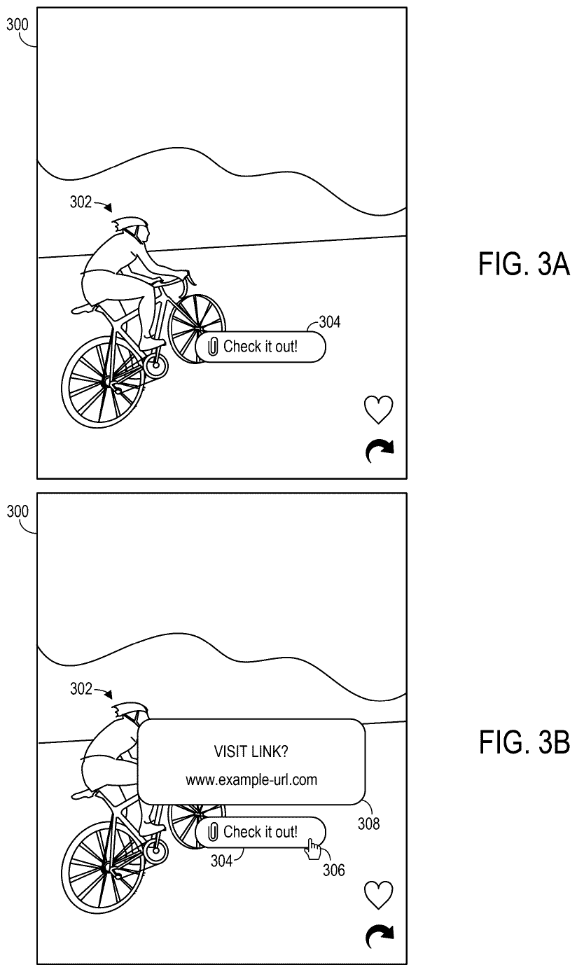

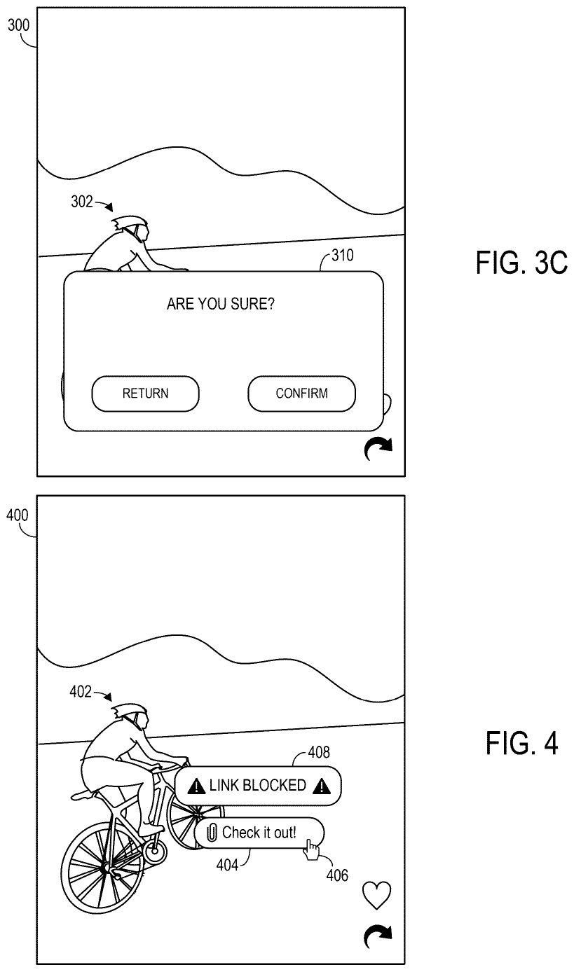

FIGS. 3A-3C depict an example UI 300 presented to a viewer of graphical content distributed using the content distribution platform. As with UI 200, it will be understood that the appearance of UI 300 is simplified and non-limiting, and presented only for the sake of explanation. In other examples, the UI may have another suitable appearance and provide additional or alternative functionality.

As shown, the UI displays graphical content 302, along with a link representation 304. The link representation was added to the graphical content as described above. In the example of FIGS. 3A-3C, the link representation was subjected to risk analysis and classified with the link approval class, which permits distribution of the link representation with the graphical content. Such risk analysis may have been performed prior to distribution of the link representation, and/or via asynchronous risk analysis during ongoing distribution of the link representation. Furthermore, in some examples, the risk classification of the link representation may change over time—e.g., in response to further analysis and/or changes in the link risk parameters.

In the example of FIG. 3B, the user has provided user input 306 to select the link representation 304. To promote user safety, in this example, selection of the link representation causes display of a link preview 308 which displays the text of the web link itself. This can enable the user to review the web link prior to accessing the web content, to confirm that the web link appears trustworthy and consistent with the user's expectations. Any suitable number of such follow-up confirmation prompts may be presented upon user selection of the link representation. For instance, in FIG. 3C, a subsequent confirmation prompt 310 is displayed after user selection of the link preview 308. If the user provides approval at confirmation prompt 310, their computing device may access the web content linked to by the web link in the link representation.

It will be understood that, in other examples, a different number of confirmation prompts may be displayed. For instance, in one example, selection of the link representation may directly cause the computing device to access the web content. In some examples, the number of confirmation prompts may be determined based on the risk class of the link representation. For instance, relatively more risky link representations may require explicit user confirmation upon selection of the link representation, while links that were assessed to be less risky may be opened immediately upon user selection of the link representation.

FIG. 4 depicts another example UI 400 presented to a viewer of graphical content distributed using the content distribution platform. As with UIs 200 and 300, it will be understood that the appearance of UI 400 is simplified and non-limiting, and presented only for the sake of explanation. In other examples, the UI may have another suitable appearance and provide additional or alternative functionality.

In this example, the UI again depicts graphical content 402 along with a link representation 404, which the user has selected through user input 406. However, in FIG. 4, the link was classified by the risk analysis subsystem with the link rejection class. Thus, while the graphical content is still distributed for viewing by users of the content distribution platform, the platform prevents access to the web content upon selection of the link representation. This is indicated by the link rejection notification 408. In this example, both the graphical content and the link representation are still distributed, although the functionality of the link representation is limited. It will be understood that, in other examples, the link representation may be removed from the graphical content, or the platform may discontinue distribution of the graphical content itself (e.g., in cases where the link representation is classified with the content rejection class discussed above).

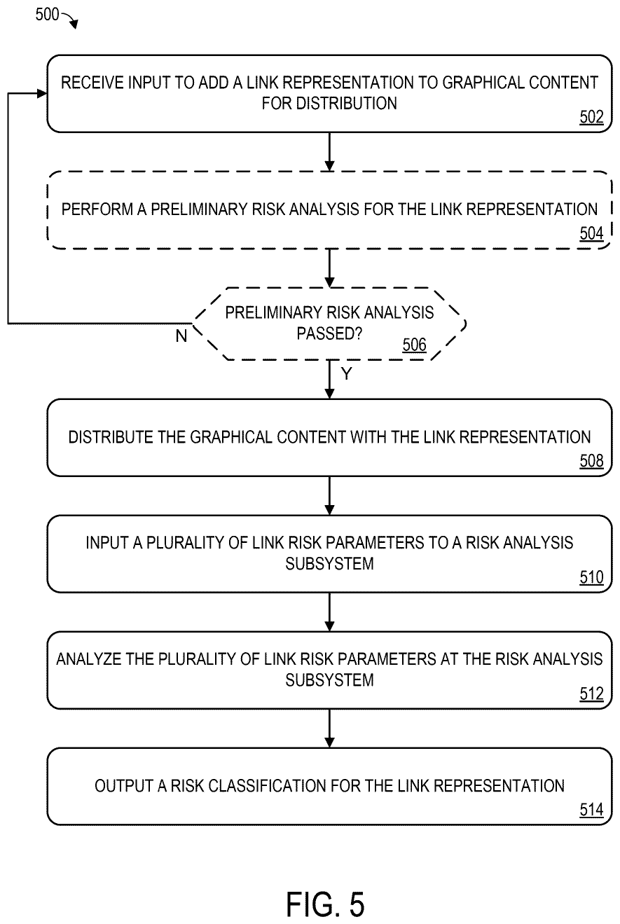

FIG. 5 illustrates an example method 500 for link risk analysis in a content distribution platform. Steps of method 500 may be initiated, terminated, and/or repeated at any suitable time and in response to any suitable condition. One or more steps of method 500 may be performed by a suitable computing system of one or more computing devices. A computing device implementing steps of method 500 may have any suitable capabilities, hardware configuration, and form factor. In some examples, method 500 may be performed by computing system 600 described below with respect to FIG. 6.

At 502, method 500 includes receiving user input to add a link representation to one or more items of graphical content for distribution. The user input may be provided through a UI associated with the content distribution platform (e.g., rendered by a client computing device used by the user), where the user selects an option to insert a link into an image, video, or other graphical media. In some implementations, the user may manually enter the link and associated display text, select a predefined link format, and/or choose from suggested links based on prior interactions. The input may specify customization preferences for the link representation, such as its placement, size, font style, and/or background styling within the one or more items of graphical content.

At 504, method 500 optionally includes performing a preliminary risk analysis for the link representation. This preliminary analysis may be conducted before the link representation is distributed, allowing for an initial assessment of potential risks associated with the link. The preliminary risk analysis may involve checking the link against a database of blacklisted character strings (e.g., known malicious or prohibited domains), analyzing the format of the link for signs of obfuscation (e.g., excessive redirections or shortened URLs), and/or evaluating metadata associated with the web content, such as its domain age, security certificates, and/or prior moderation history. In some implementations, the preliminary risk analysis may also consider user-related factors, such as the posting history of the user adding the link and whether they have previously shared flagged or restricted content. If the preliminary analysis identifies a potential risk, additional verification steps may be triggered, such as requiring user confirmation, escalating the link for manual review, and/or applying automatic restrictions before the link representation is distributed.

At 506, method 500 optionally includes determining whether the preliminary risk analysis is passed. This determination may be based on evaluating the results of the risk criteria applied during the preliminary analysis at step 504. If the link representation does not trigger any risk factors, such as being associated with a blacklisted domain, including suspicious formatting, and/or violating platform policies, it may be deemed to have passed the preliminary risk analysis, and method 500 may proceed to 508. If the preliminary risk analysis is not passed, the link representation is rejected, and the method returns to 502 for analysis of a newly submitted link representation.

At 508, method 500 includes distributing the one or more items of graphical content with the link representation. Distribution may involve making the content available to other users on the content distribution platform, either through direct sharing, public posting, inclusion in a feed or timeline, and/or other dissemination mechanisms supported by the platform. In some implementations, the one or more items of graphical content with the link representation may be modified before distribution, such as by embedding metadata related to the risk analysis, applying formatting adjustments to ensure compliance with platform guidelines, and/or appending disclaimers or warning labels if the link representation was flagged for potential risk. Once distributed, the platform may continue to monitor user interactions with the link representation, collecting engagement data that can inform future risk assessments and content moderation decisions.

At 510, method 500 includes inputting a plurality of link risk parameters for the link representation to a risk analysis subsystem. In the example of FIG. 5, this occurs during ongoing distribution of the link representation with the one or more items of graphical content. In other examples, such risk analysis may be performed prior to distribution of the link representation. The plurality of link risk parameters may include various attributes associated with the link representation, such as the surrounding graphical content, the display text, the web link itself, and web content parameters associated with the web content linked to. Additional or alternative parameters may include user-specific factors, such as the posting history and moderation record of the user sharing the link, as well as engagement metrics that indicate how other users are interacting with the link representation (e.g., reporting it as spam or malicious). Depending on the implementation, the risk analysis subsystem may receive and analyze these link risk parameters in real time, periodically, and/or in response to specific triggers, such as an increase in engagement or a report from another user. By continuously evaluating link risk parameters, the system can dynamically update the risk classification of the link representation and apply appropriate mitigation measures, such as warning users before they access the linked content, limiting the visibility of the content, and/or removing the link representation if it is determined to violate platform policies.

At 512, method 500 includes analyzing the plurality of link risk parameters at the risk analysis subsystem. This analysis may involve applying one or more risk assessment techniques, such as rule-based filtering, heuristic analysis, statistical modeling, and/or machine learning-based classification, to determine the likelihood that the link representation poses a risk. The risk analysis subsystem may compare the link risk parameters to predefined risk criteria, including blacklisted or suspicious domains, known patterns of phishing or malware distribution, URL obfuscation techniques, and/or inconsistencies between the graphical content and the linked web content.

At 514, method 500 includes outputting a risk classification for the link representation. The risk classification may indicate the assessed level of risk associated with the link representation based on the analysis performed by the risk analysis subsystem. The classification may be selected from a predefined set of risk categories, such as a link approval class that permits distribution of the link representation using the content distribution platform, a link rejection class that causes the content distribution platform to prevent access to the web content upon selection of the link representation, and a content rejection class that prevents distribution of the graphical content using the content distribution platform. The risk classification may be output in various ways, depending on the implementation. For example, it may be logged in a database for auditing purposes, stored in memory for further processing, transmitted to a moderation system for enforcement actions, and/or displayed in a user interface for review by content moderators or end users.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 6 schematically shows a non-limiting embodiment of a computing system 600 that can enact one or more of the methods and processes described above. Computing system 600 is shown in simplified form. Computing system 600 may embody the computing system 100 described above and illustrated in FIG. 1. Components of computing system 600 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 600 includes a logic processor 602 volatile memory 604, and a non-volatile storage device 606. Computing system 600 may optionally include a display subsystem 608, input subsystem 610, communication subsystem 612, and/or other components not shown in FIG. 6.

Logic processor 602 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the logic processor 602 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 606 includes one or more physical devices configured to hold instructions executable by the logic processors to implement the methods and processes described herein. When such methods and processes are implemented, the state of non-volatile storage device 606 may be transformed—e.g., to hold different data.

Non-volatile storage device 606 may include physical devices that are removable and/or built in. Non-volatile storage device 606 may include optical memory, semiconductor memory, and/or magnetic memory, or other mass storage device technology. Non-volatile storage device 606 may include nonvolatile, dynamic, static, read/write, read-only, sequential-access, location-addressable, file-addressable, and/or content-addressable devices. It will be appreciated that non-volatile storage device 606 is configured to hold instructions even when power is cut to the non-volatile storage device 606.

Volatile memory 604 may include physical devices that include random access memory. Volatile memory 604 is typically utilized by logic processor 602 to temporarily store information during processing of software instructions. It will be appreciated that volatile memory 604 typically does not continue to store instructions when power is cut to the volatile memory 604.

Aspects of logic processor 602, volatile memory 604, and non-volatile storage device 606 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 600 typically implemented in software by a processor to perform a particular function using portions of volatile memory, which function involves transformative processing that specially configures the processor to perform the function. Thus, a module, program, or engine may be instantiated via logic processor 602 executing instructions held by non-volatile storage device 606, using portions of volatile memory 604. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 608 may be used to present a visual representation of data held by non-volatile storage device 606. The visual representation may take the form of a graphical user interface (GUI). As the herein described methods and processes change the data held by the non-volatile storage device, and thus transform the state of the non-volatile storage device, the state of display subsystem 608 may likewise be transformed to visually represent changes in the underlying data. Display subsystem 608 may include one or more display devices utilizing virtually any type of technology. Such display devices may be combined with logic processor 602, volatile memory 604, and/or non-volatile storage device 606 in a shared enclosure, or such display devices may be peripheral display devices.

When included, input subsystem 610 may comprise or interface with one or more user-input devices such as a keyboard, mouse, touch screen, camera, or microphone.

When included, communication subsystem 612 may be configured to communicatively couple various computing devices described herein with each other, and with other devices. Communication subsystem 612 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 600 to send and/or receive messages to and/or from other devices via a network such as the Internet.

The following paragraphs provide additional description of the subject matter of the present disclosure:

In an example, a computing system comprises: a processor; and a storage device holding instructions executable by the processor to: receive a user input to add a link representation to one or more items of graphical content for distribution using a content distribution platform, wherein the link representation includes one or more characters of display text and a link to web content; input a plurality of link risk parameters associated with the link representation to a risk analysis subsystem, wherein the link risk parameters include at least one of the one or more items of graphical content, the one or more characters of display text, the link to the web content, or one or more web content parameters associated with the web content; at the risk analysis subsystem, analyze the plurality of link risk parameters to determine a risk classification for the link representation based at least in part on one or more risk criteria; and output, from the risk analysis subsystem, the risk classification for the link representation. In this example or any other example, the risk classification is selected from three different link risk classes, including a link approval class that permits distribution of the link representation using the content distribution platform, a link rejection class that causes the content distribution platform to prevent access to the web content upon selection of the link representation, and a content rejection class that prevents distribution of the one or more items of graphical content using the content distribution platform. In this example or any other example, the risk classification for the link representation is output by the risk analysis subsystem during ongoing distribution of the one or more items of graphical content and the link representation using the content distribution platform. In this example or any other example, the instructions are further executable to perform a preliminary risk analysis prior to distribution of the one or more items of graphical content and the link representation using the content distribution platform. In this example or any other example, the instructions are further executable to, in response to the risk classification for the link representation indicating potential risk, discontinue distribution of the link representation using the content distribution platform. In this example or any other example, the one or more risk criteria include one or more of a blacklist of character strings, a format of the link to the web content, a topic of the one or more items of graphical content, and a topic of the web content. In this example or any other example, the web content parameters include one or more of text data of the web content, image data of the web content, and a quantity of link redirects caused by selection of the link to the web content. In this example or any other example, the instructions are further executable to, prior to distribution of the link representation using the content distribution platform, determine whether a user submitting the link representation satisfies authorization criteria, wherein the authorization criteria include one or more of a follower count of the user, prior content posting history for the user, and prior content moderation history for the user. In this example or any other example, the instructions are further executable to, in response to detecting that the link representation is used to access the web content more than a threshold number of times, flag the link representation for manual review. In this example or any other example, one or more visual properties of the link representation are customizable, including a position of the link representation relative to the one or more items of graphical content.

In an example, a method for link risk analysis in a content distribution platform comprises: receiving a user input to add a link representation to one or more items of graphical content for distribution using the content distribution platform, wherein the link representation includes one or more characters of display text and a link to web content; inputting a plurality of link risk parameters associated with the link representation to a risk analysis system, wherein the link risk parameters include at least one of the one or more items of graphical content, the one or more characters of display text, the link to the web content, or one or more web content parameters associated with the web content; analyzing the plurality of link risk parameters to determine a risk classification for the link representation based at least in part on one or more risk criteria; and outputting the risk classification for the link representation. In this example or any other example, the risk classification is selected from three different link risk classes, including a link approval class that permits distribution of the link representation using the content distribution platform, a link rejection class that causes the content distribution platform to prevent access to the web content upon selection of the link representation, and a content rejection class that prevents distribution of the one or more items of graphical content using the content distribution platform. In this example or any other example, the risk classification for the link representation is output by the risk analysis subsystem during ongoing distribution of the one or more items of graphical content and the link representation using the content distribution platform. In this example or any other example, the method further comprises performing a preliminary risk analysis prior to distribution of the one or more items of graphical content and the link representation using the content distribution platform. In this example or any other example, the method further comprises, in response to the risk classification for the link representation indicating potential risk, discontinuing distribution of the link representation using the content distribution platform. In this example or any other example, the one or more risk criteria include one or more of a blacklist of character strings, a format of the link to the web content, a topic of the one or more items of graphical content, and a topic of the web content. In this example or any other example, the web content parameters include one or more of text data of the web content, image data of the web content, and a quantity of link redirects caused by selection of the link to the web content. In this example or any other example, the method further comprises, prior to distribution of the link representation using the content distribution platform, determining whether a user submitting the link representation satisfies authorization criteria, wherein the authorization criteria include one or more of a follower count of the user, prior content posting history for the user, and prior content moderation history for the user. In this example or any other example, the method further comprises in response to detecting that the link representation is used to access the web content more than a threshold number of times, flagging the link representation for manual review.

In an example, a computing system comprises: a processor; and a storage device holding instructions executable by the processor to: receive a user input to add a link representation to one or more items of graphical content for distribution using a content distribution platform, wherein the link representation includes one or more characters of display text and a link to web content; perform a preliminary risk analysis for the link representation, wherein the preliminary risk analysis includes determining whether the display text and the link to the web content include any blacklisted character strings; distribute the one or more items of graphical content with the link representation using the content distribution platform; during ongoing distribution of the one or more items of graphical content and the link representation, input a plurality of link risk parameters associated with the link representation to a risk analysis subsystem, wherein the link risk parameters include at least one of the one or more items of graphical content, the one or more characters of display text, the link to the web content, or one or more web content parameters associated with the web content; at the risk analysis subsystem, analyze the plurality of link risk parameters to determine a risk classification for the link representation based at least in part on one or more risk criteria; and output, from the risk analysis subsystem, the risk classification for the link representation, wherein the risk classification is selected from three different link risk classes, including a link approval class that permits continued distribution of the link representation using the content distribution platform, a link rejection class that causes the content distribution platform to prevent access to the web content upon selection of the link representation, and a content rejection class that prevents distribution of the one or more items of graphical content using the content distribution platform.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system, comprising:
a processor; and
a storage device holding instructions executable by the processor to:
receive a user input to add a link representation to one or more items of graphical content for distribution using a content distribution platform, wherein the link representation includes one or more characters of display text and a link to web content;
input a plurality of link risk parameters associated with the link representation to a risk analysis subsystem, wherein the link risk parameters include at least one of the one or more items of graphical content, the one or more characters of display text, the link to the web content, or one or more web content parameters associated with the web content;
at the risk analysis subsystem, analyze the plurality of link risk parameters to determine a risk classification for the link representation based at least in part on one or more risk criteria; and
output, from the risk analysis subsystem, the risk classification for the link representation.

2. The computing system of claim 1, wherein the risk classification is selected from three different link risk classes, including a link approval class that permits distribution of the link representation using the content distribution platform, a link rejection class that causes the content distribution platform to prevent access to the web content upon selection of the link representation, and a content rejection class that prevents distribution of the one or more items of graphical content using the content distribution platform.

3. The computing system of claim 1, wherein the risk classification for the link representation is output by the risk analysis subsystem during ongoing distribution of the one or more items of graphical content and the link representation using the content distribution platform.

4. The computing system of claim 3, wherein the instructions are further executable to perform a preliminary risk analysis prior to distribution of the one or more items of graphical content and the link representation using the content distribution platform.

5. The computing system of claim 3, wherein the instructions are further executable to, in response to the risk classification for the link representation indicating potential risk, discontinue distribution of the link representation using the content distribution platform.

6. The computing system of claim 1, wherein the one or more risk criteria include one or more of a blacklist of character strings, a format of the link to the web content, a topic of the one or more items of graphical content, and a topic of the web content.

7. The computing system of claim 1, wherein the web content parameters include one or more of text data of the web content, image data of the web content, and a quantity of link redirects caused by selection of the link to the web content.

8. The computing system of claim 1, wherein the instructions are further executable to, prior to distribution of the link representation using the content distribution platform, determine whether a user submitting the link representation satisfies authorization criteria, wherein the authorization criteria include one or more of a follower count of the user, prior content posting history for the user, and prior content moderation history for the user.

9. The computing system of claim 1, wherein the instructions are further executable to, in response to detecting that the link representation is used to access the web content more than a threshold number of times, flag the link representation for manual review.

10. The computing system of claim 1, wherein one or more visual properties of the link representation are customizable, including a position of the link representation relative to the one or more items of graphical content.

11. A method for link risk analysis in a content distribution platform, the method comprising:
receiving a user input to add a link representation to one or more items of graphical content for distribution using the content distribution platform, wherein the link representation includes one or more characters of display text and a link to web content;
inputting a plurality of link risk parameters associated with the link representation to a risk analysis system, wherein the link risk parameters include at least one of the one or more items of graphical content, the one or more characters of display text, the link to the web content, or one or more web content parameters associated with the web content;
analyzing the plurality of link risk parameters to determine a risk classification for the link representation based at least in part on one or more risk criteria; and
outputting the risk classification for the link representation.

12. The method of claim 11, wherein the risk classification is selected from three different link risk classes, including a link approval class that permits distribution of the link representation using the content distribution platform, a link rejection class that causes the content distribution platform to prevent access to the web content upon selection of the link representation, and a content rejection class that prevents distribution of the one or more items of graphical content using the content distribution platform.

13. The method of claim 11, wherein the risk classification for the link representation is output by the risk analysis subsystem during ongoing distribution of the one or more items of graphical content and the link representation using the content distribution platform.

14. The method of claim 13, further comprising performing a preliminary risk analysis prior to distribution of the one or more items of graphical content and the link representation using the content distribution platform.

15. The method of claim 13, further comprising, in response to the risk classification for the link representation indicating potential risk, discontinuing distribution of the link representation using the content distribution platform.

16. The method of claim 11, wherein the one or more risk criteria include one or more of a blacklist of character strings, a format of the link to the web content, a topic of the one or more items of graphical content, and a topic of the web content.

17. The method of claim 11, wherein the web content parameters include one or more of text data of the web content, image data of the web content, and a quantity of link redirects caused by selection of the link to the web content.

18. The method of claim 11, further comprising, prior to distribution of the link representation using the content distribution platform, determining whether a user submitting the link representation satisfies authorization criteria, wherein the authorization criteria include one or more of a follower count of the user, prior content posting history for the user, and prior content moderation history for the user.

19. The method of claim 11, further comprising, in response to detecting that the link representation is used to access the web content more than a threshold number of times, flagging the link representation for manual review.

20. A computing system, comprising:
a processor; and
a storage device holding instructions executable by the processor to:
receive a user input to add a link representation to one or more items of graphical content for distribution using a content distribution platform, wherein the link representation includes one or more characters of display text and a link to web content;
perform a preliminary risk analysis for the link representation, wherein the preliminary risk analysis includes determining whether the display text and the link to the web content include any blacklisted character strings;
distribute the one or more items of graphical content with the link representation using the content distribution platform;
during ongoing distribution of the one or more items of graphical content and the link representation, input a plurality of link risk parameters associated with the link representation to a risk analysis subsystem, wherein the link risk parameters include at least one of the one or more items of graphical content, the one or more characters of display text, the link to the web content, or one or more web content parameters associated with the web content;
at the risk analysis subsystem, analyze the plurality of link risk parameters to determine a risk classification for the link representation based at least in part on one or more risk criteria; and
output, from the risk analysis subsystem, the risk classification for the link representation, wherein the risk classification is selected from three different link risk classes, including a link approval class that permits continued distribution of the link representation using the content distribution platform, a link rejection class that causes the content distribution platform to prevent access to the web content upon selection of the link representation, and a content rejection class that prevents distribution of the one or more items of graphical content using the content distribution platform.
